(19) United States
(12) Patent Application Publication
(10) Pub. No.: US 2026/0295401 A1
(43) Pub. Date: Oct. 1, 2026

(54) DYNAMIC DELIVERY OF AN ASSET BASED ON DETERMINED END USE

(71) Applicant: SONY INTERACTIVE ENTERTAINMENT INC., Tokyo (JP)

(72) Inventors: Kelvin Yong, Irvine, CA (US); Michael Stopa, San Mateo, CA (US); Harshil Shah, Yorba Linda, CA (US); Xiaoyong ye, Pleasanton, CA (US)

(21) Appl. No.: 19/097,343

(22) Filed: Apr. 1, 2025

(51) Int. Cl. A63F 13/40

(52) U.S. Cl. CPC A63F 13/40

(57) ABSTRACT

Systems and methods for dynamically delivering an asset based on a determined end use are provided. A computing system can receive a user input signal generated at a user device of a user and a video game signal related to an execution of a video game remotely from the user device. The computing system can determine a parameter of an asset of the video game by executing an artificial intelligence (AI) model. For example, the AI model can determine, using the user input signal and video game signal, a context of the execution of the video game. The context can indicate an end use of the asset by the user. The AI model can generate, using the determined context, an output indicating the parameter. The computing system can cause the asset to be rendered based on the parameter and to be transmitted as rendered to the user device.

### BACKGROUND

Computer rendering of graphics or other assets requires central processing unit (CPU) and graphic processing unit (GPU) resources. Different users may require different frame rates for image processing, which can result in differences in resource consumption. Portions of a display outputting an asset to a user may be presented in higher resolution than other portions to conserve processing resources. The portions of the display presented in lower resolution can be selected to minimize disruptions or reductions of the user’s viewing experience. But an end use of the displayed asset can vary frequently, such as when the user switches between different tasks.

### BRIEF DESCRIPTION OF THE DRAWINGS

Features, embodiments, and advantages of the present disclosure are better understood when the following Detailed Description is read with reference to the accompanying drawings.

FIG. 1 illustrates an example computer system for dynamically delivering an asset based on a determined end use, according to embodiments of the present disclosure.

FIG. 2 illustrates an example block diagram of using an artificial intelligence (AI) model to determine an end use of an asset, according to embodiments of the present disclosure.

FIG. 3 illustrates an example block diagram of a computing system for dynamically adjusting a delivery of an asset based on a determined end use, according to embodiments of the present disclosure.

FIG. 4 illustrates an example block diagram of another computing system for dynamically adjusting a delivery of an asset based on a determined end use, according to embodiments of the present disclosure.

FIG. 5 illustrates an example system to train an AI model for determining an end use of an asset, according to embodiments of the present disclosure.

FIG. 6 illustrates a flowchart of an example process for dynamically delivering an asset based on a determined end use, according to embodiments of the present disclosure.

FIG. 7 illustrates a flowchart of an example process for using an AI model to determine an end use of an asset, according to embodiments of the present disclosure.

FIG. 8 illustrates an example of a hardware system suitable for implementing a computer system, according to embodiments of the present disclosure.

In the appended figures, similar components and/or features may have the same reference label.

### DETAILED DESCRIPTION OF THE INVENTION

In the following description, for the purposes of explanation, specific details are set forth in order to provide a thorough understanding of certain embodiments. However, it will be apparent that various embodiments may be practiced without these specific details. The figures and description are not intended to be restrictive. The word “exemplary” is used herein to mean “serving as an example, instance, or illustration.” Any embodiment or design described herein as “exemplary” is not necessarily to be construed as preferred or advantageous over other embodiments or designs.

Embodiments of the present disclosure are directed to, among other things, dynamic delivery of an asset based on a determined end use of the asset. The asset can include virtual content, such as an image, a video, or other suitable content items, related to an execution of a video game. For example, a user may operate a computing device to request a particular asset as part of developing the video game. In some examples, the delivery of the asset to the computing device can be dynamically controlled or managed using an artificial intelligence (AI) model, such as a large language model (LLM), a neural network, etc. For example, an output of the AI model can indicate a parameter of rendering the asset, such as a video quality, a type of data compression to use when transmitting the asset, etc. In some examples, the user may contribute to a particular aspect of developing the video game. For example, each user participating in the development of the video game may have a respective role, such as a game designer, a visual artist, etc. Accordingly, each user can have a different end use when requesting an asset, such as graphical content or audio content (e.g., a three dimensional model that includes a mesh, primitives, texture, etc. or a volumetric neural rendering model such as one using Gaussian splatting) that can be presented as part of an execution of the video game. In certain aspects, the end use of the asset can vary based on a role of the user. For example, a game designer may focus on developing gameplay mechanics of the video game. On the other hand, a graphic artist may focus on developing graphics of the video game. In certain aspects, the end use of the asset can vary based on a particular task being performed by the user. Accordingly, the parameter used to render assets for a particular user can change based on each task performed by the particular user.

To illustrate, consider the following example. A user can interact with a user device as a graphic artist of a video game under development. The user may primarily focus on developing graphics (e.g., characters, objects, environments, special effects, etc.) for the video game. By way of example, the user may provide user input via the user device to manipulate a playable character to ensure that lighting and shading effects of the playable character are consistent. Based on the user’s interactions with the playable character and characteristics associated with the playable character or the video game, the AI model can determine an end use of game content to be rendered and transmitted to the user device. For example, the AI model can use pattern matching to determine that the user’s interactions fit an input pattern corresponding to an end use of the user reviewing in-game surface texture of the playable character. Based on the end use, the AI model can recommend a parameter by which to render or transmit game content including the playable character to the user device. For example, a graphic artist may need a higher image or video quality when performing tasks related to developing the graphics of the video game compared to another game developer who may perform other tasks related to generating a game script.

In some examples, the AI model can determine a portion of the asset to prioritize (e.g., render with a higher quality compared to a remaining portion of the asset). The AI model can analyze user interaction data that can indicate a behavior or interest of the user during gameplay or while performing a particular task. By way of example, the user interaction data can indicate that the user moves to a specific position at a particular camera angle to look for pixel perfect issues (e.g., aberrations, blurring, distortions, or other imperfections related to pixels of an image or a video frame). In some examples, the user interaction data can include gaze tracking data that can be collected by an imaging device. Using the user interaction data or other suitable inputs, the AI model can determine a point of interest within a particular frame or associated with the asset. In some examples, the AI model can determine based on the point of interest a subset of the asset or a frame to render at a higher quality compared to a remaining subset of the asset or the frame. By way of example, if the video game is a football video game, the AI model can determine that the point of interest corresponds to a location of a football. An output of the AI model can include a predicted location of the football and a quality at which to render the football.

Embodiments of the present disclosure can provide several advantages over existing techniques to adjust a delivery of an asset to a user. Computer rendering and transmission of an asset can consume a varying amounts of computing resources, such as processing power, storage, bandwidth, etc., depending on one or more parameters of the asset. For example, using a lossless compression protocol to transmit the asset can consume more processing resources compared to using a lossy compression protocol. Some embodiments described herein involve executing an AI model to determine at least one parameter of the asset based on an end use of the asset by the user requesting the asset. In particular, the AI model can determine the parameter based on an input to the AI model such that computing resources associated with rendering or transmitting the asset can be conserved. For example, the parameter of the asset can be determined to reduce computational demands while still providing the asset with sufficient quality to enable the user to successfully perform a task related to the video game. Accordingly, the delivery of the asset can vary based on user interactions with a user device to reduce resource consumption.

In the interest of clarity of explanation, the embodiments can be described herein in connection with video game development. However, the embodiments are not limited as such and can similarly apply to other applications or any other type of a computer system.

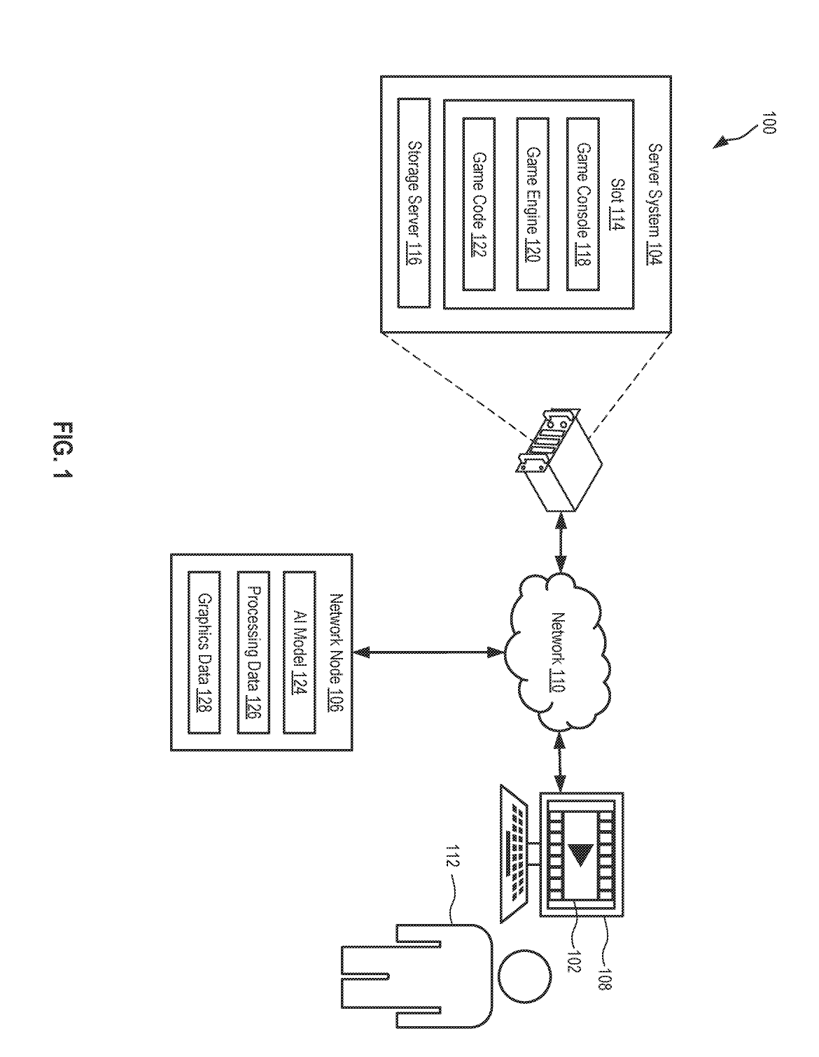

FIG. 1 illustrates an example computer system 100 for dynamically delivering an asset 102 based on a determined end use, according to embodiments of the present disclosure. As illustrated, the computer system 100 includes a server system 104, a network node 106, and a user device 108. Network node 106 can be separate from server system 104 and user device 108. Components of the computer system 100 can be communicatively coupled, such as via a network 110. Network 110 can be a local network, a wide area network (e.g., the Internet), or another suitable type of wireless communication.

A user 112 can operate user device 108 to perform one or more tasks. User device 108 can be any suitable computing device, such as a laptop, a desktop, a mobile device, a gaming console, etc. User device 108 can include a processor and a memory (e.g., a non-transitory computer-readable storage medium) storing computer-readable instructions that can be executed by the processor and that, upon execution by the processor, cause user device 108 to perform operations related to various applications. In some examples, at least one application can be executed to facilitate development of a video game or another suitable type of media.

User 112 can operate user device 108 via an input device, such as a keyboard, a touchscreen, a touchpad, a mouse, an optical system, a microphone, a camera, or other user devices suitable for receiving input of user 112. For example, a microphone may allow user 112 to interact with user device 108 using various voice commands. As another example, a camera may allow user 112 to interact with user device 108 using various gesture commands. In some examples, the tasks performed by user 112 can include playing a video game presented on an output device (e.g., a display) of user device 108. Additionally or alternatively, the tasks can include interacting with applications that can be available locally (e.g., downloaded on user device 108) or remotely (e.g., hosted on a server). For example, user 112 can interact with user device 108 to play a media file from a local storage of user device 108. In some examples, each user interaction can generate a respective user interaction signal.

Server system 104 can deliver asset 102 to user device 108. In some examples, server system 104 can execute a video game application to initiate a game session of a video game. The video game application can be a computer application executable to present video game content, receive user interaction with the video game content, and accordingly update the video game content. For example, server system 104 can deliver asset 102 as part of the game session, such as to provide gameplay graphics. Delivering asset 102 can involve rendering asset 102 and transmitting asset 102 as rendered to user device 108. Once user device 108 receives asset 102 from server system 104, user device 108 can display asset 102, such as via an output device of user device 108. Asset 102 can be digital content. In some examples, asset 102 can include visual content (e.g., a video, an image, vector artwork, a user interface, etc.). In some examples, asset 102 can include audio content (e.g., speech, music, sound effects, etc.).

Server system 104 can include one or more servers that can provide computing resources, such as over network 110. As shown, server system 104 includes a server slot 114 and a storage server 116. In some implementations, storage server 116 can provide centralized non-volatile storage (e.g., a hard drive, a solid-state drive, etc.). In some implementations, storage server 116 can provide video encoding or network connectivity to components of server system 104. For example, storage server 116 can include accelerators, such as hardware or software video encoders, graphics processing units (GPUs), etc. Other configurations are possible.

In some examples, server system 104 can include one or more server slots 114 that can be logical segments of machine resources (e.g., processing resources or storage resources). For example, each server slot can be physical hardware corresponding to a gaming console 118. As another example, each server slot can be a virtual instance of gaming console 118. As shown, server slot 114 can include game engine 120 that can execute game code 122 that is similarly included in server slot 114. In some examples, executing game code 122 can involve rendering asset 102 (e.g., one or more frames of a video) related to the video game. Rendering asset 102 can include generating an image or other digital content from input data, such as a software model. Asset 102 can be transmitted (e.g., streamed) to user device 108 as rendered. In some implementations, a quality or a rendering technique used to render asset 102 can vary based on an output of an artificial intelligence (AI) model 124.

As shown, computer system 100 includes network node 106 communicatively coupled with server system 104 and user device 108 via network 110. In some examples, network node 106 can be an edge device, such as a computing device located at or near an edge of a network (e.g., network 110). In certain aspects, network node 106 can be positioned closer to user device 108 than server system 104. Close proximity between network node 106 and user device 108 can reduce response times or other times associated with data retrieval (e.g., downloading). In some examples, network node 106 can include or host AI model 124. Other configurations are possible, such as in some implementations in which AI model 124 is hosted by server system 104. As described herein, server system 104 can use an output of AI model 124 to adaptively determine or adjust how asset 102 is rendered or transmitted to user device 108. In some examples, AI model 124 can be trained to output a recommendation for a parameter of asset 102. As an example, the parameter can be a quality at which to render asset 102. As another example, the parameter can be a compression protocol to apply to asset 102 before transmitting asset 102 to user device 108.

In some examples, AI model 124 can generate the recommendation based on at least one user input signal and at least one video game signal. As described herein, the user input signal can be generated in response to an interaction of user 112 with user device 108. For example, the user input signal can include one or more of a mouse click, a key press, an audio input, a chat input, natural language input, or video game controller input. In some examples, the video game signal can relate to an execution of the video game or to the asset. The video game signal can include one or more of a type of the asset, a previous version of the asset, or a setting of the video game. For example, the video game signal can indicate a type of the asset, such as whether the asset includes video content, image content, audio content, etc. As another example, the video game signal can indicate whether the asset is source code, a two-dimensional or three-dimensional model of a playable character, special effects, part of a background of a game environment, part of a foreground of the game environment, etc. As yet another example, the video game signal can include information related to historical assets that have been previously rendered.

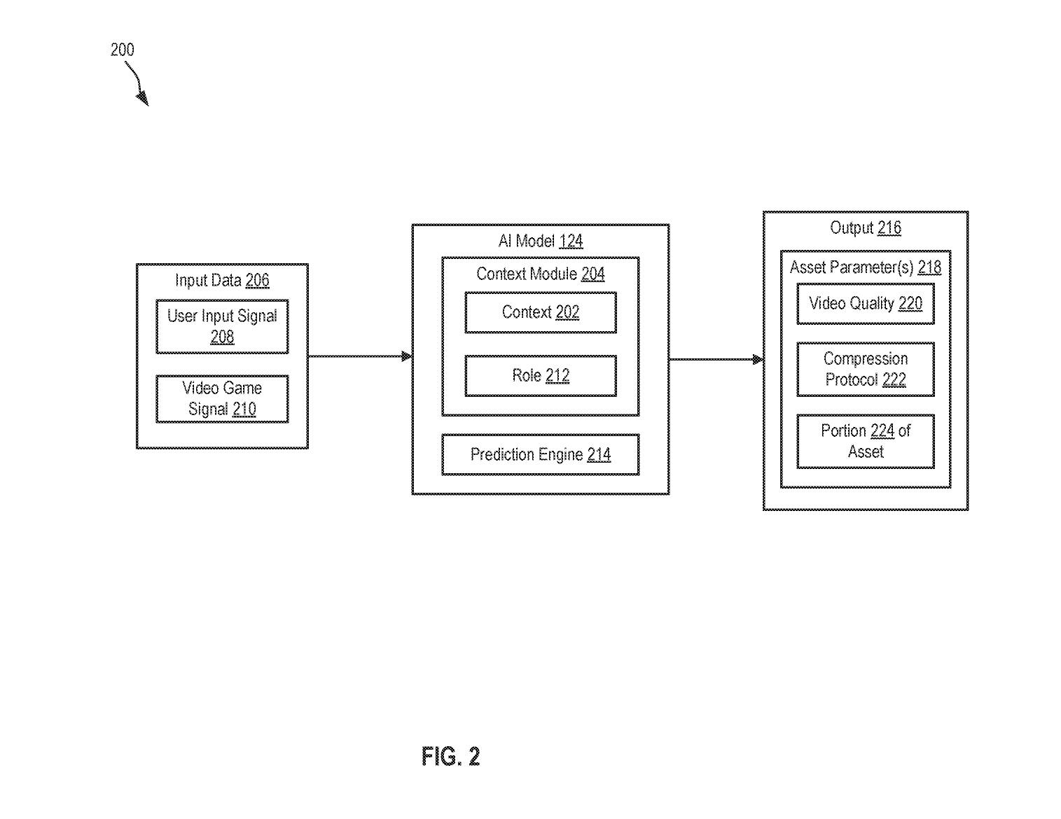

In some examples, AI model 124 can use the user input signal and the video game signal to determine a context related to asset 102, such as a task performed by user 112 that involves asset 102. By way of example, user 112 can be a game developer who specializes in a specific game element, such as game code, level design, user interface, gaming environment, character design, etc. The task performed by user 112 can vary based on a specialization of user 112. AI model 124 can be trained on historical user interaction data or historical video game data to distinguish between different patterns or other characteristics in the historical user interaction data or historical video game data that can indicate the task or context associated with asset 102. In some implementations, AI model 124 can use pattern recognition to match an input pattern of the user input signal with an existing pattern corresponding to a particular context or end use of asset 102. Additional description related to AI model 124 is provided below with respect to FIG. 2.

In some examples, executing game code 122 can generate processing data 126 and graphics data 128. Processing data 126 can include binary text data generated as part of executing a video game. In some examples, network node 106 can continuously capture processing data 126 from server system 104, such as processing data 126 within a predefined time interval (e.g., 30 seconds, a minute, etc.). Graphics data 128 can include digital content, such as images or video frames, that can be generated as part of executing a video game. In some examples, a delay in timing may exist between processing data 126 (e.g., graphics processing unit (GPU) states or memory states of server slot 114) and graphics data 128 received by user device 108. In some examples, the delay can be caused by buffering of the graphics data as part of a transmission from server system 104 to user device 108. Resolving or troubleshooting performance issues can be difficult due to this delay. AI model 124 can facilitate troubleshooting by synchronizing processing data 126 and graphics data 128 received from server system 104, which can resolve the delay between processing data 126 and graphics data 128. In some examples, AI model 124 can synchronize processing data 126 and graphics data 128 by mapping a particular data point of processing data 126 to a corresponding content item (e.g., a video frame) of graphics data 128.

Although FIG. 1 illustrates that AI model 124 is part of network node 106, the embodiments of the present disclosure are not limited as such. For example, certain embodiments may lack network node 106 and instead include AI model 124 as part of server system 104. As another example, certain embodiments can include AI model 124 as part of user device 108.

FIG. 2 illustrates an example block diagram 200 of using an artificial intelligence (AI) model 124 to determine an end use of an asset, according to embodiments of the present disclosure. Different types of AI model 124 are possible. In some examples, AI model 124 can be a large language model (LLM) that can perform natural language processing tasks, such as generating an output including text. AI model 124 can be a multi-modal model and/or a generative AI (genAI) model. In some examples, AI model 124 can be a neural network that can have one or more layers that can each include one or more nodes. Each layer of the neural network can perform a specific task, such as data processing, pattern recognition, etc.

Delivery of the asset to a user device of the user can vary based on the end use of the asset. In some examples, the asset can be a content item (e.g., an image, a video frame, etc.) requested by a user as part of an execution of a video game. The end use of the asset can, for example, relate to a task to be completed by the user using the asset. For example, the user can be a game developer who may request the asset to perform one or more tasks as part of developing the video game. As described herein, AI model 124 can be executed to determine a parameter of the asset (e.g., asset 102 of FIG. 1). The asset can be delivered based on the parameter determined by AI model 124. In some examples, AI model 124 can be communicatively coupled with a game engine or another suitable computing component that can render the asset based on an output of AI model 124.

In some examples, AI model 124 can determine the parameter using a context 202 of generating the asset. As shown, in some examples, AI model 124 includes a context module 204 that can determine context 202 related to the asset. As described herein, context 202 can indicate the end use of the asset by the user, such as a task to be performed by the user using the asset. In some examples, AI model 124 can receive input data 206 that can include a user input signal 208 and a video game signal 210. As described herein, in some examples, user input signal 208 can correspond to a user interaction with the user device, such as using a mouse, a keyboard, a keypad, a video game controller, a touch screen, etc. As described herein, in some examples, video game signal 210 can indicate a property or characteristic of the video game that the asset is part of or of the asset. For example, video game signal 210 can indicate which game element is included in the asset, such as a particular playable character, a non-player character, special effects, etc. Other types of data can be provided as part of input data 206. Using input data 206, AI model 124 can determine context 202. For example, AI model 124 can use input data 206 to determine a role 212 of the user. In some implementations, each role can be associated with a respective set of possible tasks. For example, once role 212 of the user is determined, a suitable task of a corresponding set of possible tasks can be selected based on input data 206 as part of determining context 202.

In some examples, AI model 124 includes a prediction engine 214 that can generate an output 216 indicating at least one parameter 218 of the asset. As shown, parameter 218 can include a video quality 220 of the asset. In some implementations, prediction engine 214 can use at least context 202 generated by context module 204 to generate a recommended video quality 220 at which to render the asset. By way of example, video quality 220 outputted by prediction engine 214 can be different based on whether context module 204 determines that the user is requesting the asset to perform a task related to debugging code or related to visual design of a video game. In particular, prediction engine 214 can output a lower video quality to perform a task related to debugging code compared to performing another task related to visual design of the video game. As another example, context 202 can relate to role 212 of the user. Each role can be associated with a corresponding level of quality or a corresponding priority. For example, a graphics programmer role can be assigned a higher priority with respect to receiving an asset with high fidelity compared to a user interface designer role. Accordingly, prediction engine 214 can output different parameters for the graphics programmer role and the user interface designer role.

In some examples, output 216 can indicate a compression protocol 222 to apply to the asset. For example, compression protocol 222 can be a lossy compression protocol or a lossless compression protocol. Additionally or alternatively, output 216 can indicate a portion 224 of the asset to apply compression protocol 222. In some examples, portion 224 of the asset can be a specific region or a specific object of the asset. In some implementations, prediction engine 214 can use context 202, a user input signal 208, a video game signal 210, or a combination thereof to predict a portion of the asset that is of interest to the user. For example, user input signal 208 can indicate a current position of a cursor of the user device. As another example, user input signal 208 can include gaze tracking data that can indicate where the user is looking at a display of the user device. The portion 224 of interest to the user can be assigned a different parameter compared to a remaining portion of the asset.

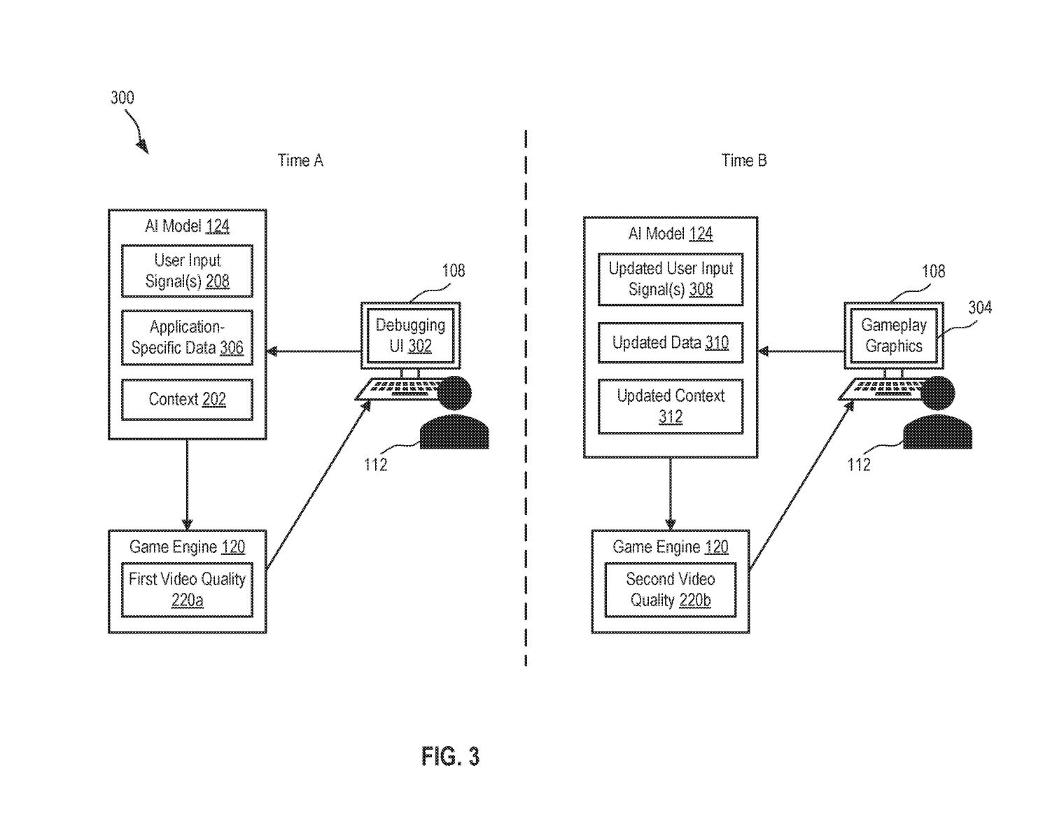

FIG. 3 illustrates an example block diagram of a computing system 300 for dynamically adjusting a delivery of an asset (e.g., asset 102 of FIG. 1) based on a determined end use, according to embodiments of the present disclosure. In some examples, computing system 300 can be a gaming console, a server, a network node, or another suitable system distributed therebetween. Examples of such computing systems are described above with respect to FIG. 1. Certain aspects of FIG. 3 are described below with reference to components of FIGS. 1 and 2. As described herein, in some examples, an artificial intelligence (AI) model 124 can be executed to control how the asset 102 is rendered or transmitted to a user device 108 based on the end use of the asset 102.

As shown, user interactions of a user 112 with user device 108 can vary over time. In some examples, user 112 may have different tasks to work on at different points in time. FIG. 3 shows two example scenarios. A first scenario occurs at time A where user 112 interacts with a debugging user interface 302 outputted for display at user device 108. A second scenario occurs at time B where user 112 interacts with gameplay graphics 304 of a video game that are outputted for display at user device 108. At time A, user 112 can interact with debugging user interface 302 outputted at user device 108 to write or modify game code, such as to address a vulnerability detected in the game code. In some examples, debugging user interface can include a section providing a code editor and another section providing a visual of the video game corresponding to game code in the code editor. Examples of user interactions by user 112 with debugging user interface 302 can include a mouse click to select a menu option in the debugging user interface or one or more key presses to write or modify the game code. Each user interaction by user 112 can generate a respective user input signal.

An AI model 124 can receive one or more user input signals 208 as part of its input to determine a parameter of an asset requested by user 112. AI model 124 additionally can use application-specific data 306 as part of its input to determine the parameter of the asset. Application-specific data 306 can vary based on an application executed or in use on user device 108. As shown for time A, a debugging tool or a software development environment can be in use. For example, AI model 124 can receive application-specific data 306 that can indicate that a particular application associated with debugging user interface 302 is in use by user 112. As another example, application-specific data 306 can indicate that execution of the game code has reached a breakpoint.

In some examples, AI model 124 can use input (e.g., user input signal(s) 208, application-specific data 306, or a combination thereof) to determine a context 202 related to the asset requested by user 112. For example, AI model 124 can analyze the input to determine that user 112 has provided user input to execute a portion of the game code in a code editor of debugging user interface 302. Executing the portion of the game code can involve rendering the asset and transmitting the rendered asset to be displayed at user device 108. In some examples, AI model 124 can use context 202 to generate an output indicating a video quality as a parameter of rendering the asset. For example, context 202 can indicate that user 112 is performing a debugging process, which can need less fidelity compared to modifying texture of an in-game element. AI model 124 can use context 202 to determine a minimum level of the video quality to enable user 112 to perform a task using the rendered asset while conserving processing resources.

Once AI model 124 generates its output, a game engine 120 can render the asset for display based on the parameter indicated in the output of AI model 124. In some examples, game engine 120 can be a software framework that can facilitate video game development by including various programs or functionalities related to graphics rendering, animation, scripting, streaming, etc. In some examples, AI model 124 can be separate from game engine 120. In other examples, AI model 124 can be part of game engine 120. As shown, AI model 124 can determine a first video quality 220a at which game engine 120 is recommended to render the asset. In some examples, game engine 120 can receive an output of AI model 124 indicating the first video quality 220a. Once game engine 120 receives the output of AI model 124, game engine 120 can render the asset according to the first video quality 220a. Once rendered, the asset can be transmitted to user device 108.

At time B, user device 108 displays gameplay graphics 304. By way of example, user 112 can switch from a first task of debugging game code performed at time A to a second task of performing a test run of the game code. For example, user 112 can perform the test run to determine whether the game code modified at time A causes an unexpected glitch or another malfunction in gameplay graphics 304 generated as part of executing the game code. In some examples, user 112 can interact with user device 108 to switch from displaying debugging user interface 302 to displaying gameplay graphics 304. For example, user device 108 can perform the switch to displaying gameplay graphics 304 after receiving a series of mouse clicks generated by user 112. These interactions by user 112 with user device 108 can generate one or more updated user input signals 308. In some examples, switching to displaying gameplay graphics 304 can generate updated application-specific data 310, such as due to executing a different application to initiate a game session to perform the test run. In some implementations, updated application-specific data 310 can include one or more video game signals, such as a type of asset to be provided as part of gameplay graphics 304. AI model 124 can receive updated input that can include updated user input signal(s) 308, updated application-specific data 310, or a combination thereof. Using the updated input, AI model 124 can generate an updated context 312 related to a requested asset (e.g., a playable character of the video game). For example, based on at least on updated user input signals 308 including joystick movements, AI model 124 can determine updated context 312 indicating that the requested asset will be used by user 112 to test gameplay of the video game using the playable character. Using updated context 312, AI model 124 can transmit a new output to game engine 120 that can indicate an updated parameter of the asset. In particular, the new output of AI model 124 can indicate a second video quality 220b recommended for game engine 120 to render the requested asset. Once game engine 120 receives the new output, game engine 120 can render the requested asset based on the second video quality 220b and output the requested asset as rendered to user device 108.

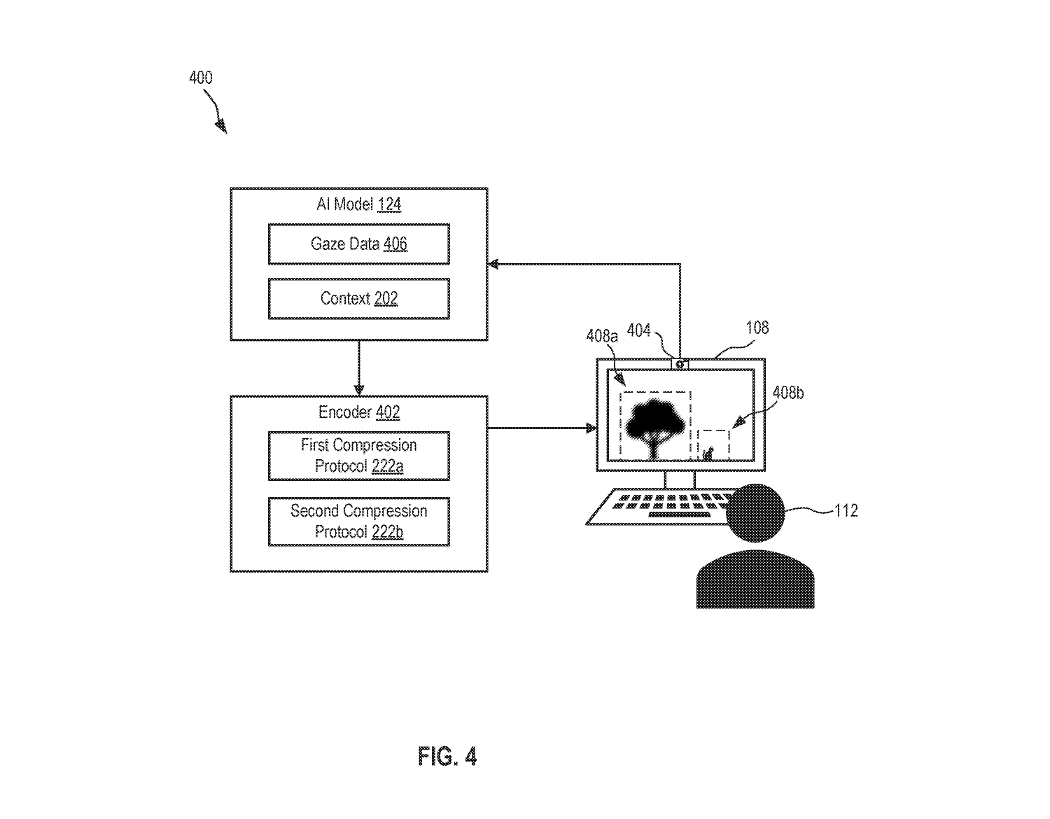

FIG. 4 illustrates an example block diagram of another computing system 400 for dynamically adjusting a delivery of an asset (e.g., the asset 102 of FIG. 1) based on a determined end use, according to embodiments of the present disclosure. In some examples, computing system 400 can be a gaming console, a server, a network node, or another suitable system distributed therebetween. As described herein, in some examples, the delivery of the asset can involve applying a particular compression protocol to compress the asset, such as to encode information using fewer bits than an original representation of the asset. Compressing the asset can reduce a file size associated with the asset, which can facilitate storage or transmission of the asset. For example, a reduced file size can correspond to a reduction in transmission time. As another example, the compressed asset can use less storage resources compared to an uncompressed asset. An encoder 402 can apply a compression protocol to the asset. The compression protocol can be reversed by a decoder to obtain the uncompressed asset. In some examples, the decoder can be located in a user device 108 that can receive the compressed asset from encoder 402.

As described herein, AI model 124 can use input data to generate an output indicating a parameter by which to render or transmit the asset. With respect to FIG. 4, the parameter determined by AI model 124 can be a compression protocol, such as a first compression protocol 222a or a second compression protocol 222b. As shown, AI model 124 can be in communication with encoder 402 that can apply at least one compression protocol 222 to compress the asset. In some examples, encoder 402 may be part of server system 104 of FIG. 1. As described herein, compressing the asset can reduce resource consumption associated with transmission, display, or playback of the asset. In some examples, encoder 402 can compress each asset or a respective portion of a particular asset using different compression protocols. Certain compression protocols are lossless in which little to no data is discarded as part of compressing the asset. In some examples, lossless compression protocols can use statistical redundancy to reduce a file size by minimizing redundancy. Accordingly, an uncompressed or an original version of the asset compressed using a lossless compression protocol can be reconstructed without data loss. Certain compression protocols are lossy in which a portion of data of the asset is selectively discarded as part of compressing the asset. In some examples, the portion of discarded data can be selected based on human perception of visual data. Using a lossless compression protocol can consume more computing resources compared to using a lossy compression protocol while providing a comparatively higher quality asset.

In some examples, the input data of AI model 124 can include movement data related to movements of a user 112, such as movements during a game session of a video game. As shown, computing system 400 can include an imaging device 404 that can capture imaging data. For example, imaging device 404 can capture one or more images or video that can be used to determine gaze data 406 that can include eye movements of user 112 over time, such as while user 112 interacts with user device 108 during a game session. Other types of data can be provided as part of the input data to AI model 124. As described herein, the input data can include user input signals or video game signals.

In some examples, using the input data, AI model 124 can determine a context 202 of the asset indicating that user 112 is focused on a particular portion of the asset. As shown, asset can include a first portion 408a and a second portion 408b. Based on context 202, AI model 124 can generate an output indicating to apply a first compression protocol 222a and a second compression protocol 222b to a respective portion of the asset. In some examples, AI model 124 can select the compression protocols 222a-b from a set of compression protocols based on context 202. The first compression protocol 222a and the second compression protocol 222b can be different with respect to a respective degree of data loss. As described herein, a lossy compression protocol can have a greater degree of data loss compared to a lossless compression protocol. The first compression protocol 222a can be applied to a particular portion of the asset while the second compression protocol 222b can be applied to a remaining portion of the asset. Accordingly, different compression protocols can be applied to different portion of the asset based on context 202 determined by AI model 124.

In some examples, AI model 124 can indicate in its output the respective portion of the asset to which to apply each compression protocol. For example, the output can indicate to apply the first compression protocol 222a to the first portion 408a of the asset and the second compression protocol 222b to the second portion 408b of the asset. As shown, the first portion 408a of the asset can be more pixelated compared to the second portion 408b of the asset, which can correspond to the second compression protocol 222b having greater data loss compared to the first compression protocol 222a. In some examples, the asset can be rendered and transmitted as a video that can include one or more video frames. The compression protocols 222a-b can be applied to a respective portion of each video frame of the asset.

As described herein, in some examples, certain portions of the asset can be prioritized with respect to quality (e.g., image quality, video quality, etc.) at which these portions of the asset are rendered. For example, an avatar of user 112 in the video game may be rendered at a higher quality compared to a non-player character in the video game. As another example, a foreground of a gaming environment can be rendered at a higher quality compared to a background of the gaming environment. A respective priority of each portion of the asset can be assigned based on the output of AI model 124. In some examples, AI model 124 can analyze gaze data 406 of user 112 to predict a landing point of user attention associated with user 112. The landing point can be a point of interest to user 112, such as corresponding to the avatar of user 112 or another object of interest (e.g., a car in a racing simulation game). For example, gaze data 406 can include historical eye movement data of user 112 during gameplay. In some implementations, AI model 124 can map the historical eye movement data to a particular object of interest and can predict the landing point based on movement of the particular object. Based on the predicted landing point, AI model 124 can assign a respective priority to certain portions of the asset. For example, AI model can assign a higher priority to a portion of the asset including or adjacent to the predicted landing point compared to another portion of the asset far away from the predicted landing point.

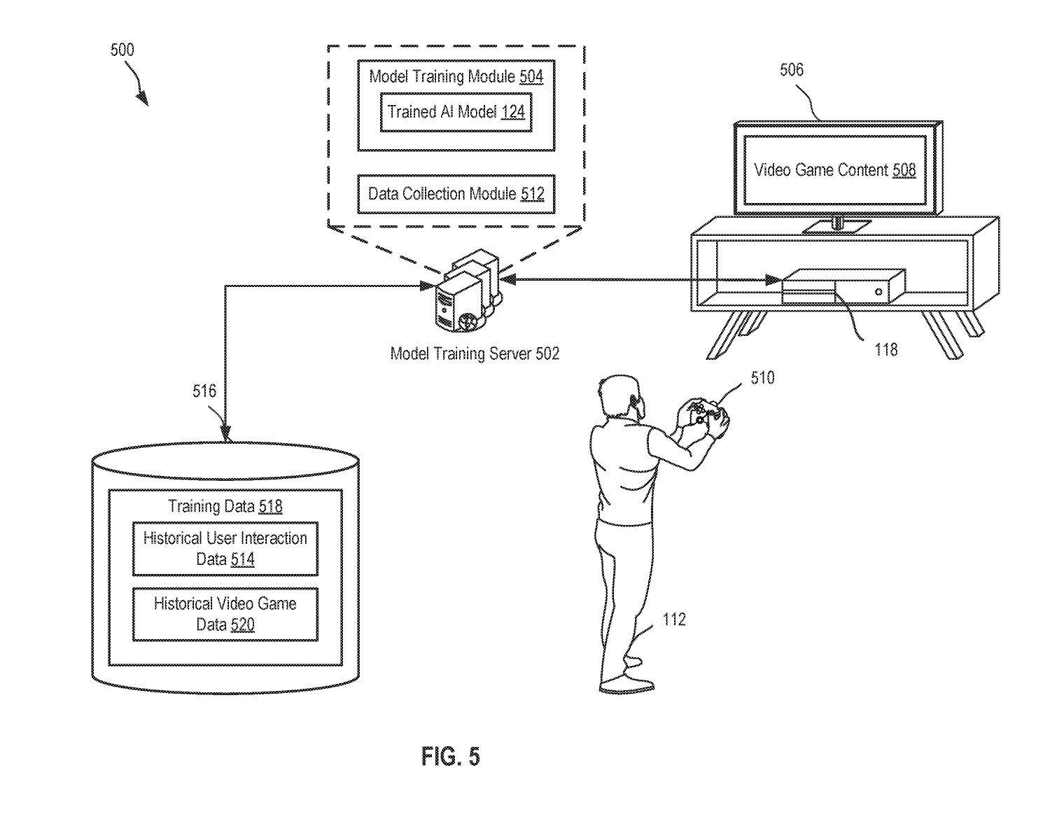

FIG. 5 illustrates an example system 500 to train an artificial intelligence (AI) model 124 for determining an end use of an asset, according to embodiments of the present disclosure. In some examples, a model training server 502 can host suitable modules or programs to train AI model 124. In some implementations, AI model 124 can be provided to or hosted on another computing system once trained. In some examples, AI model 124 can undergo retraining, such as using updated training data that can include new training data sets compared to original training data initially used to train AI model 124.

As shown in FIG. 5, system 500 can include a model training server 502 to train AI model 124. In some examples, model training server 502 can be communicatively coupled with a computing device, such as a gaming console 118. As described herein, a user 112 can interact with one or more applications executable on gaming console 118. These interactions may include playing a video game presented on a display 506 communicatively coupled with gaming console 118 (e.g., over a communication bus) or interacting with a menu presented on display 506. Gaming console 118 can include a processor and a memory (e.g., a non-transitory computer-readable storage medium) storing computer-readable instructions that can be executed by the processor and that, upon execution by the processor, cause gaming console 118 to perform operations related to various applications. In particular, the computer-readable instructions can correspond to program codes for the various applications of gaming console 118, such as a video game application. In general, the video game application is a computer application executable to present video game content, receive user interaction with the video game content, and accordingly update the video game content. Upon an execution of the video game application by gaming console 118, a rendering process of gaming console 118 presents video game content 508 on display 506.

In some examples, user 112 can interact with gaming console 118 using a video game controller 510 communicatively coupled with gaming console 118 (e.g., over a wireless connection), such as to execute a game session of a video game using the video game application. Video game controller 510 is an example of an input device. Video game controller 510 may allow user 112 to interact with one or more graphical user interfaces (GUIs) or video game content 508 presented by gaming console 118 on display 506. For example, using one or more directional control inputs (e.g., a joystick and/or a directional pad), user 112 can navigate to and within various menus, dashboards, and user interface (UI) elements. Other types of the input device are possible including, a keyboard, a touchscreen, a touchpad, a mouse, an optical system, a microphone, a camera, or other user devices suitable for receiving input of a user. For example, a microphone may allow user 112 to interact with the GUIs using various voice commands. As another example, a camera may allow user 112 to interact with the GUIs using various gesture commands.

In some examples, model training server 502 can receive or collect data from gaming console 118. For example, model training server 502 can include a data collection module 512 that can obtain user interaction data generated at gaming console 118. In some examples, the user interaction data can be stored as historical interaction data 514 in a training database 516 as part of training data 518 that can be used to train AI model 125. An example of the user interaction data can include data related to gameplay of user 112 using video game controller 510, such as button presses, joystick input, etc. Another example of the user interaction data can include data related to monitoring physical movement of user 112, such as tracking eye movements of user 112 while user 112 interacts with the video game application or other applications of gaming console 118. In some examples, data collection module 512 can obtain video game data generated at gaming console 118, such as data related to assets rendered as part of the game session or data related to the video game (e.g., a genre of the video game). The video game data can be stored as historical video game data 520 in training database 516 as part of training data 518 that can be used to train AI model 124.

As described herein, model training server 502 can include model training module 504 that can be executable to generate a trained AI model 124. AI model 124 can be trained using training data 518. In some examples, training AI model 124 can involve a process of providing training data 518 to AI model 124 to adjust certain variables (e.g., weights) of AI model 124 to improve an accuracy of its predictions. For example, a loss function of AI model 124 can be used to measure model performance by quantifying a degree of error between a predicted value outputted by AI model 124 and an actual value that can be provided as part of training data 518. Training AI model 124 can involve adjusting certain variables of AI model 124 to minimize the loss function. Different types of training are possible, such as training in a supervised manner or an unsupervised manner. In supervised training, each input of training data 518 can be correlated to a desired output, enabling AI model 124 to determine or learn a mapping between the inputs of training data 518 and desired outputs. For example, training data 518 can include a sequence of key presses that can be correlated to a corresponding known input pattern of a particular user or a particular group of users having the same role. In unsupervised training, training data 518 may include inputs but not desired outputs, such that AI model 124 determines patterns or structure in the inputs of training data 518 on its own.

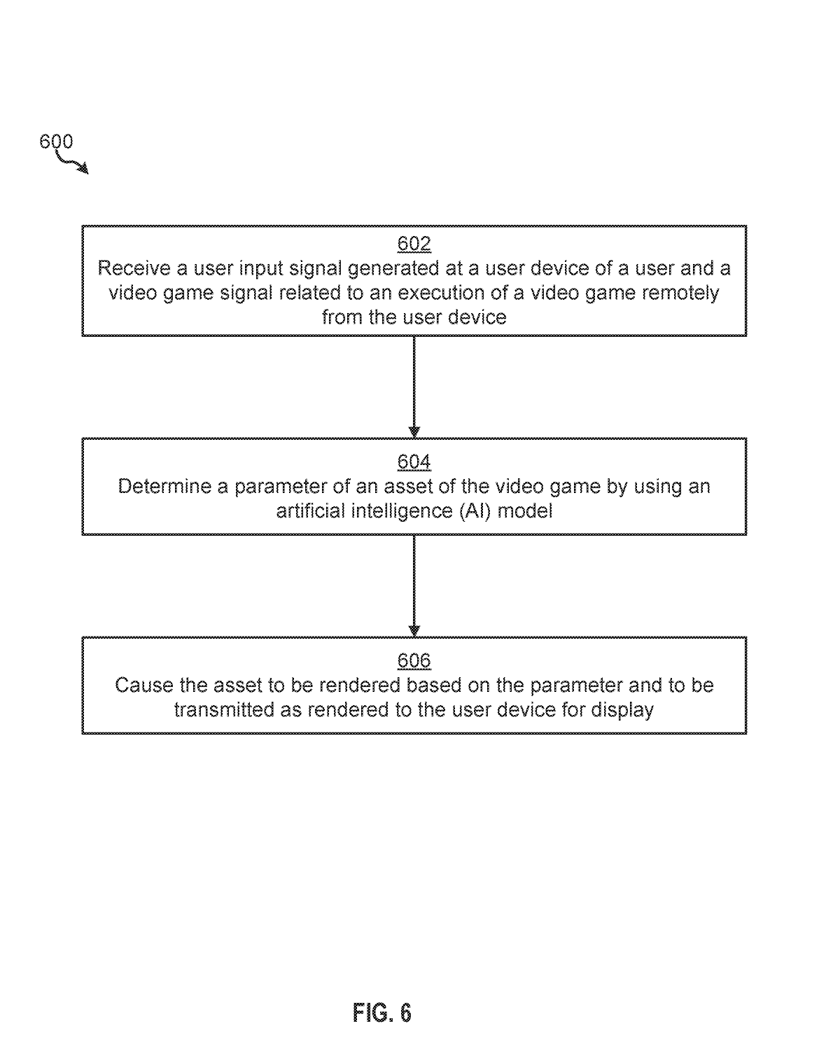

FIG. 6 illustrates a flowchart of an example process 600 for dynamically delivering an asset (e.g., asset 102 of FIG. 1) based on a determined end use, according to embodiments of the present disclosure. The operations of process 600 can be implemented as hardware circuitry and/or stored as computer-readable instructions on a non-transitory computer-readable medium of a computer system, such as any of the computer systems described herein (e.g., server system 104 in FIG. 1). As implemented, the instructions represent circuitry or code executable by the computer system. The execution of such instructions configures the computer system to perform the specific operations described herein. Each circuitry or code in combination with the computer system represents a means for performing a respective operation(s). While the operations are illustrated in a particular order, it should be understood that no particular order is necessary and that one or more operations can be omitted, skipped, and/or reordered.

In an example, process 600 includes operation 602, where the computer system receives a user input signal and a video game signal. The user input signal can be generated at a user device of a user. The video game signal can be related to an execution of a video game remotely from the user device. As shown in FIG. 1, the execution of the video game can occur on a server system remote from the user device. In some implementations, the user can provide user input to generate the user input signal at the user device. For example, the user can interact with a user interface displayed at the user device, such as displayed via an output device of the user device. The user can provide the user input using an input device communicatively coupled with the user device, such as a keyboard, a mouse, a video game controller, a touchscreen, etc. In some examples, the video game signal can provide information related to the asset, such as a previous version of the asset.

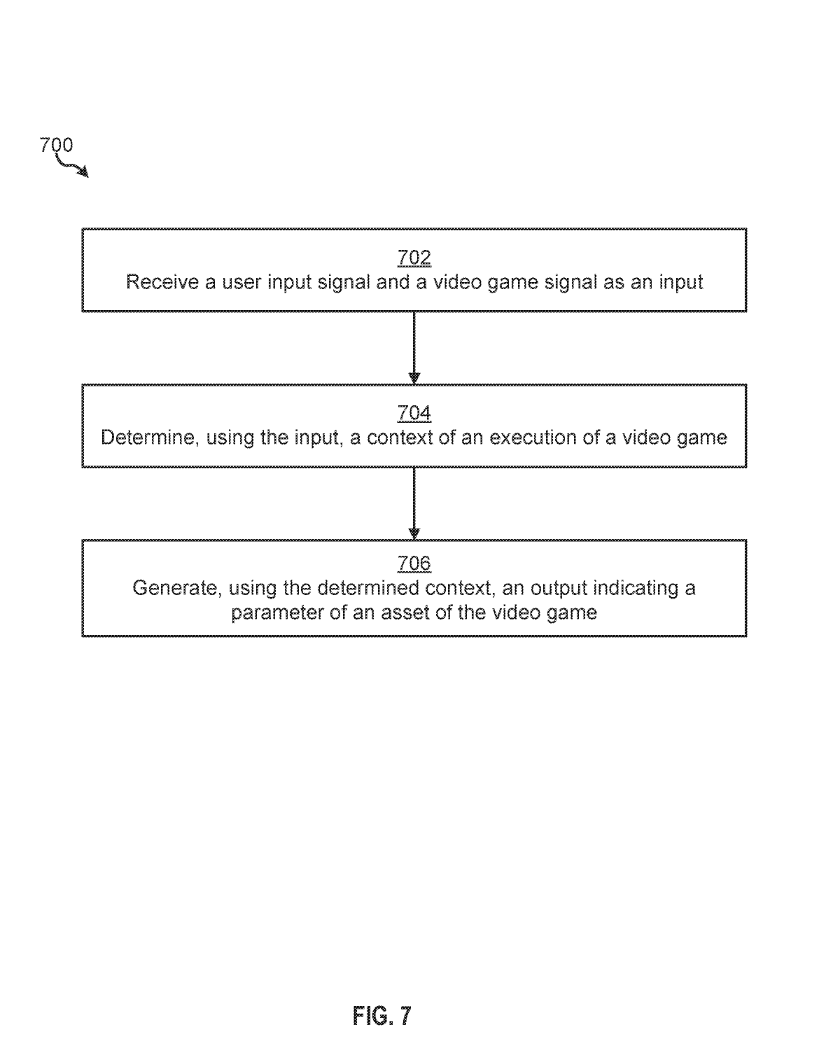

In an example, process 600 includes operation 604, where the computer system determines a parameter of an asset of the video game by using an artificial intelligence (AI) model. The computer system can execute the AI model to perform one or more steps or operations. In some examples, the AI model can be trained to use at least the user input signal and the video game signal to generate an output indicating the parameter of the asset. By way of example, the AI model can output a recommended video quality as the parameter at which to provide a video stream to the user device. Additional description related to the steps or operations performed by the AI model is provided below with respect to FIG. 7.

In an example, process 600 includes operation 606, where the computer system causes the asset to be rendered based on the parameter and to be transmitted as rendered to the user device for display. In some examples, the computer system can extract the parameter from the output of the AI model. The parameter can be a recommended quality level (e.g., a resolution, a type of compression protocol, etc.) at which to render or transmit the asset. Once the computer system obtains the parameter, the computer system can render or transmit the asset in accordance with the parameter. In some examples, the computer system can transmit the asset as rendered to the user device to resolve a request received from the user device. For example, the user device may generate a request in response to user input from the user, where the request can indicate a requested asset. The asset transmitted by the computer system to the user device as rendered can resolve the request.

FIG. 7 illustrates a flowchart of an example process 700 for using an artificial intelligence (AI) model (e.g., the AI model 124 of FIGS. 1 or 2) to determine an end use of an asset, according to embodiments of the present disclosure. The operations of process 700 can be implemented as hardware circuitry and/or stored as computer-readable instructions on a non-transitory computer-readable medium of a computer system, such as any of the computer systems described herein (e.g., server system 104 in FIG. 1). As implemented, the instructions represent circuitry or code executable by the AI model. The execution of such instructions configures the AI model to perform the specific operations described herein. Each circuitry or code in combination with the AI model represents a means for performing a respective operation(s). While the operations are illustrated in a particular order, it should be understood that no particular order is necessary and that one or more operations can be omitted, skipped, and/or reordered.

In an example, process 700 includes operation 702, where the AI model receives a user input signal and a video game signal as an input. As described herein, in some examples, the user input signal can be generated in response to a user interacting with a user device, such as using an input device communicatively coupled with the user device. In some examples, the user input signal can include information related to the user, such as a role or profile of the user. The video game signal can include information related to the asset, such as a type of the asset or historical renderings of the asset. In some implementations, the AI model can receive text data as part of the input. For example, the AI model can be a large language model that can be trained to process the text data, such as to perform a natural language processing task. In some examples, the user input signal, the video game signal, or a combination thereof can be converted into text data. In some implementations, the user input signal or the video game signal can include natural language input or chat input. Once converted, the text data can be provided as part of the input to the AI model.

In an example, process 700 includes operation 704, where the AI model determines, using the input, a context of an execution of a video game. As described herein, in some examples, the execution of the video game can occur remotely from the user device at which the user input signal is generated. For example, as shown in FIG. 1, game code 122 of a video game can be executed at a server system 104 communicatively coupled with user device 108 via a network 110. The context can indicate an end use of the asset by the user associated with the user device. In some examples, the end use can correspond to a task to be performed by the user using the asset. By way of example, a game developer can request a sprite of a playable character to evaluate one or more movements of the playable character during gameplay. The sprite can be a two-dimensional image or animation of the playable character that can be integrated into a game environment. The game developer can have an end use associated with determining whether certain movements of the sprite are consistent across different in-game environments. Accordingly, the game developer may provide user input at the user device to discontinuously move the sprite to test a walking animation or a sprinting animation at different angles or perspectives with respect to the sprite.

In some examples, the AI model can match an input pattern of the user input with a user profile corresponding to the user. For example, historical user interaction data can be stored and used to generate a respective user profile for each user. In some examples, the historical user interaction data can be sorted based on a common factor, such as similar roles. For example, the historical interaction data can undergo processing to separate the historical interaction data into a respective subset of data corresponding to a respective role. As another example, the historical user interaction data can be grouped based on which user generated a respective subset of the historical interaction data. In some implementations, the AI model can determine certain input patterns that may be present in one subset of the historical interaction data but not another subset. For example, the AI model can determine that a particular input pattern is indicative of input by a specific user. The AI model then can map the particular input pattern to a corresponding user profile of the specific user. Additional information related to the specific user can be included as part of its user profile such that once the AI model receives input from the specific user, the AI model can use the user profile to facilitate a determination of the parameter to render the asset. For example, a role or a set of typical or common tasks related to the specific user can be included in its user profile.

In an example, process 700 includes operation 706, where the AI model generates, using the determined context, an output indicating the parameter of the asset. In some implementations, the AI model can be a large language model that can generate a natural language output or a human-readable output. In some examples, the AI model can transmit the output to a computing component (e.g., game engine 120 of FIG. 1 or encoder 402 of FIG. 4). Once the output is received, the computing component can parse the output or otherwise obtain the parameter using the output of the AI model. The computing component then can render the asset based on the parameter indicated in the output.

In some examples, process 700 (e.g., operations 702 through 706) can repeat or be performed using updated input for the AI model. The updated input can include an updated user input signal or an updated video game signal. For example, the input of the AI model can change, such as due to the user switching from a first task to a second task. In some examples, the change in the input can be determined based on a change in the user input signals. For example, playing a video game can generate user input signals involving a video game controller, whereas debugging code can generate user input signals related to one or more key presses. In some implementations, at least a portion of content provided as part of the asset can change as part of the user switching to the second task, such as the content including a playable character to perform the first task and updated content including special effects to perform the second task. The updated input can be provided to the AI model to generate a new output that can indicate an updated parameter. The asset rendered using the parameter outputted at operation 706 can be updated based on the updated parameter. For example, a quality of the asset can be decreased or increased. As another example, a portion of the asset may be rendered using an updated resolution or a different compression protocol based on the new output of the AI model, while a remaining portion of the asset can remain unmodified.

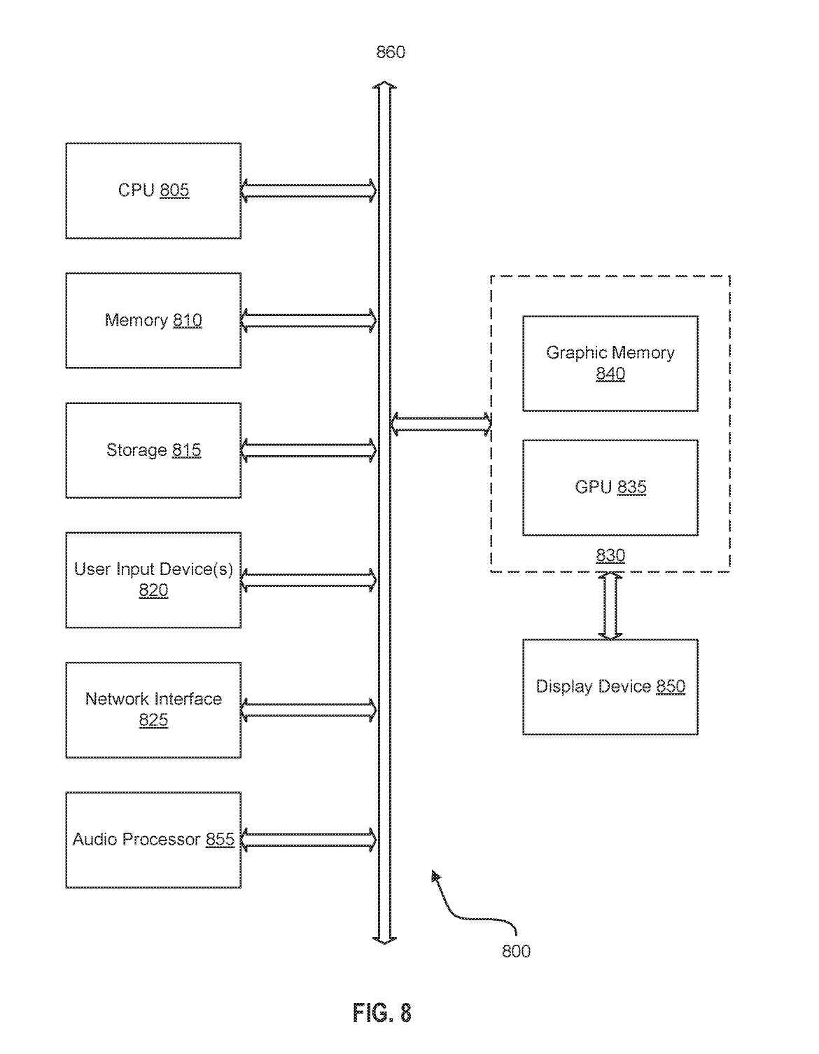

FIG. 8 illustrates an example of a hardware system suitable for implementing a computer system, according to embodiments of the present disclosure. The computer system 800 represents, for example, a video game system, a backend set of servers, or other types of a computer system. The computer system 800 includes a central processing unit (CPU) 805 for running software applications and optionally an operating system. The CPU 805 may be made up of one or more homogeneous or heterogeneous processing cores. Memory 810 stores applications and data for use by the CPU 805. Storage 815 provides non-volatile storage and other computer readable media for applications and data and may include fixed disk drives, removable disk drives, flash memory devices, and CD-ROM, DVD-ROM, Blu-ray, HD-DVD, or other optical storage devices, as well as signal transmission and storage media. User input devices 820 communicate user inputs from one or more users to the computer system 800, examples of which may include keyboards, mice, thumbsticks, touch pads, touch screens, still or video cameras, and/or microphones. Network interface 825 allows the computer system 800 to communicate with other computer systems via an electronic communications network and may include wired or wireless communication over local area networks and wide area networks such as the Internet. An audio processor 855 is adapted to generate analog or digital audio output from instructions and/or data provided by the CPU 805, memory 810, and/or storage 815. The components of computer system 800, including the CPU 805, memory 810, data storage 815, user input devices 820, network interface 825, and audio processor 855 are connected via one or more data buses 860.

A graphics subsystem 830 is further connected with the data bus 860 and the components of the computer system 800. The graphics subsystem 830 includes a graphics processing unit (GPU) 835 and graphics memory 840. The graphics memory 840 includes a display memory (e.g., a frame buffer) used for storing pixel data for each pixel of an output image. The graphics memory 840 can be integrated in the same device as the GPU 835, connected as a separate device with the GPU 835, and/or implemented within the memory 810. Pixel data can be provided to the graphics memory 840 directly from the CPU 805. Alternatively, the CPU 805 provides the GPU 835 with data and/or instructions defining the desired output images, from which the GPU 835 generates the pixel data of one or more output images. The data and/or instructions defining the desired output images can be stored in the memory 810 and/or graphics memory 840. In an embodiment, the GPU 835 includes 3D rendering capabilities for generating pixel data for output images from instructions and data defining the geometry, lighting, shading, texturing, motion, and/or camera parameters for a scene. The GPU 835 can further include one or more programmable execution units capable of executing shader programs.

The graphics subsystem 830 periodically outputs pixel data for an image from the graphics memory 840 to be displayed on the display device 850. The display device 850 can be any device capable of displaying visual information in response to a signal from the computer system 800, including CRT, LCD, plasma, and OLED displays. The computer system 800 can provide the display device 850 with an analog or digital signal.

In accordance with various embodiments, the CPU 805 is one or more general-purpose microprocessors having one or more processing cores. Further embodiments can be implemented using one or more CPUs 805 with microprocessor architectures specifically adapted for highly parallel and computationally intensive applications, such as media and interactive entertainment applications.

The components of a system may be connected via a network, which may be any combination of the following: the Internet, an IP network, an intranet, a wide-area network (“WAN”), a local-area network (“LAN”), a virtual private network (“VPN”), the Public Switched Telephone Network (“PSTN”), or any other type of network supporting data communication between devices described herein, in different embodiments. A network may include both wired and wireless connections, including optical links. Many other examples are possible and apparent to those skilled in the art in light of this disclosure. In the discussion herein, a network may or may not be noted specifically.

In the foregoing specification, the invention is described with reference to specific embodiments thereof, but those skilled in the art will recognize that the invention is not limited thereto. Various features and aspects of the above-described invention may be used individually or jointly. Further, the invention can be utilized in any number of environments and applications beyond those described herein without departing from the broader spirit and scope of the specification. The specification and drawings are, accordingly, to be regarded as illustrative rather than restrictive.

It should be noted that the methods, systems, and devices discussed above are intended merely to be examples. It must be stressed that various embodiments may omit, substitute, or add various procedures or components as appropriate. For instance, it should be appreciated that, in alternative embodiments, the methods may be performed in an order different from that described, and that various steps may be added, omitted, or combined. Also, features described with respect to certain embodiments may be combined in various other embodiments. Different aspects and elements of the embodiments may be combined in a similar manner. Also, it should be emphasized that technology evolves and, thus, many of the elements are examples and should not be interpreted to limit the scope of the invention.

Specific details are given in the description to provide a thorough understanding of the embodiments. However, it will be understood by one of ordinary skill in the art that the embodiments may be practiced without these specific details. For example, well-known circuits, processes, algorithms, structures, and techniques have been shown without unnecessary detail in order to avoid obscuring the embodiments.

Also, it is noted that the embodiments may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure.

Moreover, as disclosed herein, the term “memory” or “memory unit” may represent one or more devices for storing data, including read-only memory (ROM), random access memory (RAM), magnetic RAM, core memory, magnetic disk storage mediums, optical storage mediums, flash memory devices, or other computer-readable mediums for storing information. One or more memories can store instructions executable to perform one or more operations. The term “computer-readable medium” includes, but is not limited to, portable or fixed storage devices, optical storage devices, wireless channels, a sim card, other smart cards, and various other mediums capable of storing, containing, or carrying instructions or data. In some embodiments, the computer-readable storage medium can have program code instructions stored therein that can be executable by a processor to perform a method.

Furthermore, embodiments may be implemented by hardware, software, firmware, middleware, microcode, hardware description languages, or any combination thereof. When implemented in software, firmware, middleware, or microcode, the program code or code segments to perform the necessary tasks may be stored in a computer-readable medium such as a storage medium. Processors may perform the necessary tasks.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain. “About” includes within a tolerance of ±0.01%, ±0.1%, ±1%, ±2%, ±3%, ±4%, ±5%, ±8%, ±10%, ±15%, ±20%, ±25%, or as otherwise known in the art. “Substantially” refers to more than 46%, 135%, 90%, 100%, 105%, 109%, 109.9% or, depending on the context within which the term substantially appears, value otherwise as known in the art.

Additionally, spatially relative terms, such as “bottom” or “top” and the like can be used to describe an element and/or feature’s relationship to other element(s) and/or feature(s) as, for example, illustrated in the figures. It will be understood that the spatially relative terms are intended to encompass different orientations of the device in use and/or operation in addition to the orientation depicted in the figures. For example, if the device in the figures is turned over, elements described as a “bottom” surface can then be oriented “above” other elements or features. The device can be otherwise oriented (e.g., rotated 90 degrees or at other orientations) and the spatially relative descriptors used herein interpreted accordingly.

Having described several embodiments, it will be recognized by those of skill in the art that various modifications, alternative constructions, and equivalents may be used without departing from the spirit of the invention. For example, the above elements may merely be a component of a larger system, wherein other rules may take precedence over or otherwise modify the application of the invention. Also, a number of steps may be undertaken before, during, or after the above elements are considered. Accordingly, the above description should not be taken as limiting the scope of the invention.

What is claimed is:

1. A computer-implemented method comprising:
receiving a user input signal generated at a user device of a user and a video game signal related to an execution of a video game remotely from the user device;
determining a parameter of an asset of the video game by using an artificial intelligence (AI) model, the AI model configured to:
receive the user input signal and the video game signal as an input;
determine, using the input, a context of the execution of the video game, the context indicating an end use of the asset by the user; and
generate, using the determined context, an output indicating the parameter of the asset; and
causing the asset to be rendered based on the parameter and to be transmitted as rendered to the user device for display.

2. The computer-implemented method of claim 1, further comprising:
determining that the input of the AI model has changed;
determining an updated parameter of the asset by using the AI model using an updated input, the updated input comprising an updated user input signal or an updated video game signal; and
updating the asset displayed at the user device based on the updated parameter.

3. The computer-implemented method of claim 1, wherein the asset is rendered and transmitted as a video comprising a plurality of video frames, and wherein the method further comprises, for each video frame of the plurality of video frames:
transmitting the video frame to the user device, wherein a portion of the video frame is compressed using a first compression protocol and a remaining portion of the video frame is compressed using a second compression protocol different from the first compression protocol.

4. The computer-implemented method of claim 3, further comprising:
selecting the first compression protocol from a plurality of compression protocols using the context; and
determining the portion of the video frame to be compressed using the first compression protocol based on the user input signal or the video game signal.

5. The computer-implemented method of claim 4, wherein the output of the AI model identifies the portion of the video frame to be compressed using the first compression protocol.

6. The computer-implemented method of claim 1, further comprising:
converting the user input signal and the video game signal to be provided to the AI model into text data; and
providing the text data as the input to the AI model to determine the parameter of the asset.

7. The computer-implemented method of claim 1, wherein the AI model is trained to predict a landing point of user attention on a display of the user device, and wherein the AI model is trained using training data related to historical user interactions by the user with the video game.

8. The computer-implemented method of claim 1, further comprising:
receiving, by a network node hosting the AI model, processing data and graphics data generated by the execution of the video game, wherein the graphics data comprises a plurality of video frames outputted for display; and
synchronizing the processing data and the graphics data by at least mapping a particular data point of the processing data to a corresponding video frame of the graphics data.

9. The computer-implemented method of claim 1, wherein the user input signal comprises one or more of: a mouse click, a key press, an audio input, a chat input, natural language input, or video game controller input.

10. The computer-implemented method of claim 1, wherein the video game signal comprises one or more of: a type of the asset, a previous version of the asset, or a setting of the video game.

11. The computer-implemented method of claim 1, wherein the AI model is provided on the user device, on a server, or on a network node separate from the user device or the server.

12. A system comprising:
one or more processors; and
one or more memories storing instructions that, upon execution by the one or more processors, configure the system to:
receive a user input signal generated at a user device of a user and a video game signal related to an execution of a video game remotely from the user device;
determine a parameter of an asset of the video game by using an artificial intelligence (AI) model, the AI model configured to:
receive the user input signal and the video game signal as an input;
determine, using the input, a context of the execution of the video game, the context indicating an end use of the asset by the user; and
generate, using the determined context, an output indicating the parameter of the asset; and
cause the asset to be rendered based on the parameter and to be transmitted as rendered to the user device for display.

13. The system of claim 12, wherein the one or more processors are further configured to:
determine that the input of the AI model has changed;
determine an updated parameter of the asset by using the AI model using an updated input, the updated input comprising an updated user input signal or an updated video game signal; and
update the asset displayed at the user device based on the updated parameter.

14. The system of claim 12, wherein the asset is rendered and transmitted as a video comprising a plurality of video frames, and wherein the one or more processors are further configured to, for each video frame of the plurality of video frames:
transmit the video frame to the user device, wherein a portion of the video frame is compressed using a first compression protocol and a remaining portion of the video frame is compressed using a second compression protocol different from the first compression protocol.

15. The system of claim 14, wherein the one or more processors are further configured to:
select the first compression protocol from a plurality of compression protocols using the context; and
determine the portion of the video frame to be compressed using the first compression protocol based on the user input signal or the video game signal.

16. The system of claim 12, the one or more processors are further configured to:
convert the user input signal and the video game signal to be provided to the AI model into text data; and
provide the text data as the input to the AI model to determine the parameter of the asset.

17. The system of claim 12, wherein the AI model is trained to predict a landing point of user attention on a display of the user device, and wherein the AI model is trained using training data related to historical user interactions by the user with the video game.

18. A computer-readable storage medium having stored therein program code instructions that, when executed by a processor in a computer system, cause the computer system to perform a method comprising:
receiving a user input signal generated at a user device of a user and a video game signal related to an execution of a video game remotely from the user device;
determining a parameter of an asset of the video game by using an artificial intelligence (AI) model, the AI model configured to:
receive the user input signal and the video game signal as an input;
determine, using the input, a context of the execution of the video game, the context indicating an end use of the asset by the user; and
generate, using the determined context, an output indicating the parameter of the asset; and
causing the asset to be rendered based on the parameter and to be transmitted as rendered to the user device for display.

19. The computer-readable storage medium of claim 18, the method further comprising:
determining that the input of the AI model has changed;
determining an updated parameter of the asset by using the AI model using an updated input, the updated input comprising an updated user input signal or an updated video game signal; and
updating the asset displayed at the user device based on the updated parameter.

20. The computer-readable storage medium of claim 19, wherein the asset is rendered and transmitted as a video comprising a plurality of video frames, and wherein the method further comprises, for each video frame of the plurality of video frames:
transmitting the video frame to the user device, wherein a portion of the video frame is compressed using a first compression protocol and a remaining portion of the video frame is compressed using a second compression protocol different from the first compression protocol.
